(19) United States
(12) Patent Application Publication
(10) Pub. No.: US 2011/0311705 A1
(43) Pub. Date: Dec. 22, 2011

(54) ROASTED GREEN TEA BEVERAGE PACKED IN CONTAINER

(75) Inventors: Keisuke Numata, Shizuoka (JP); Kazunobu Tsuru, Shizuoka (JP); Fuyuki Fujihara, Shizuoka (JP)

(73) Assignee: ITO EN, LTD.

(21) Appl. No.: 13/203,103

(22) PCT Filed: Feb. 25, 2010
(86) PCT No.: PCT/JP2010/052982

§ 371 Date: Aug. 24, 2011

(30) Foreign Application Priority Data
Feb. 27, 2009 (JP) 2009-047420

(51) Int. Cl. A23F 3/14

(52) U.S. Cl. 426/597

(57) ABSTRACT

Disclosed is a roasted green tea (Hojicha) beverage packed in a container which has a strong roasted aroma, a light taste and a refreshing aftertaste and can be drunk delectably even in a cold state. Specifically disclosed is a roasted green tea beverage packed in a container, characterized by: the concentration of saccharides, i.e., the sum of monosaccharides and disaccharides, being 60-220 ppm; the concentration ratio of disaccharides to monosaccharides (disaccharides/monosaccarides) being 5.0-15.0; and the concentration ratio of the aforesaid saccharides to gallic acid (saccharides/gallic acid) being 2.0-5.0. It is preferred that the concentration ratio of catechin showing electron localization to soluble solid matters originating in tea leaves [catechin showing electron localization/(soluble solid matters originating in tea leaves×100)] is 5.0-9.0. Also, it is preferred that the ratio (catechin showing electron localization/saccharides) is 0.8-1.8.

### TECHNICAL FIELD

The present invention relates to a roasted green tea beverage packed in a container that contains an extraction of roasted green tea that is extracted from roasted tea leaves as a major component, which is filled into a plastic bottle or a can or the like.

### BACKGROUND ART

A roasted green tea beverage extracted from roasted tea leaves has unique odor, and is a favorite beverage that is drunk by from babies to the elderly.

As an invention that relates to a tea beverage extracted from such roasted green tea or roasted tea leaves, for example, there is a roasted green tea in which precipitate, turbidity, aggregate and the like are prevented by extraction of tea leaves with water reduction-treated by electrolysis, and the like (see Patent Document 1 described below).

In addition, there is a tea beverage in which bitter taste or astringent taste of polyphenol is suppressed by containing polyphenol, components of a tea leaf extract extracted from roasted tea leaves and the like, and α-cyclodextrin (see Patent Document 2 described below).

### PRIOR ART DOCUMENT

### Patent Document

Patent Document 1: Japanese Patent Application Laid-Open (JP-A) No. 2001-275569
Patent Document 2: JP-A No. 2008-136367

### DISCLOSURE OF THE INVENTION

### Problems to be Solved by the Invention

Along with popularization of a roasted green tea beverage, particularly a roasted green tea beverage packed in a container, consumer taste and drinking situations have also become diversified, and a characteristic roasted green tea beverage packed in a container that has unique taste and odor is demanded.

In order to strengthen roasting aroma of a roasted green tea beverage, roasting of tea leaves may be intensified. However, then, bitter taste, coarse taste, bitterness and the like occur, and refreshing feeling is suppressed. Particularly, unique odor of a roasted green tea in a roasted green tea beverage was barely sensed in a cold state.

To resolve such problems, the present invention provides a novel roasted green tea beverage packed in a container, which has strong roasting aroma, and gives clean and yet refreshing aftertaste, and can be drunk even in a cold state.

### Means for Solving the Problems

The roasted green tea beverage packed in a container of the present invention is characterized in that the concentration of saccharides, which is the sum of the concentration of monosaccharides and the concentration of disaccharides, is 60 ppm to 220 ppm, the ratio of the concentration of disaccharides relative to the concentration of monosaccharides (disaccharides/monosaccharides) is 5.0 to 15.0, and the ratio of the concentration of saccharides relative to the concentration of gallic acid (saccharides/gallic acid) is 2.0 to 5.0.

The roasted green tea beverage packed in a container of the present invention makes it possible to obtain a novel roasted green tea beverage packed in a container that has strong roasting aroma, and clean and yet refreshing aftertaste, and can be drunk delectably even in a cold state, by adjustment of the concentration of saccharides which is a sum of the concentration of monosaccharides and the concentration of disaccharides, the concentration ratio of disaccharides to monosaccharides, and the ratio of the concentration of saccharides to the concentration of gallic acid.

### Mode for Carrying Out the Invention

Hereinafter, one illustrative embodiment of the roasted green tea beverage packed in a container of the present invention will be explained. However, the present invention is not limited to this illustrative embodiment.

The present roasted green tea beverage packed in a container is a beverage obtained by filling a liquid containing an extraction liquid or an extract that is obtained by extraction of a roasted green tea as a major component, into a container, and is a beverage that presents red tea color, and is a tea that has unique savory odor. The liquid includes, for example, a liquid that comprises only an extraction liquid that is obtained by extraction of roasted green tea leaves, a liquid obtained by dilution of the extraction liquid, a liquid obtained by mixing of the tea extraction liquids with each other, a liquid obtained by addition of an additive to any of the above-mentioned liquids, or a liquid obtained by dispersion of those dried of any of the above-mentioned liquids and the like. The “major component” encompasses a meaning that containing of other components is acceptable within a range of not impeding the functions of the major component. At this time, the content ratio of the major component is not specified, but an extraction liquid or an extract that is obtained by extraction of a green tea, preferably takes up 50% or more by mass, particularly 70% or more by mass, and particularly 80% or more by mass (including 100%) in the solid content concentration in the beverage.

In addition, the kind of green tea is not particularly limited. For example, the kind of green tea includes broadly teas that are classified as a non-fermented tea such as a steamed tea, a decocted tea, a refined green tea, a green powdered tea, a Bancha tea, a bead green tea, an oven-roasted tea, a Chinese green tea and the like, and also encompasses a blend thereof in 2 or more kinds. In addition, cereals such as a brown rice, a aroma such as jasmine and the like may be also added thereto.

One illustrative embodiment of the roasted green tea beverage packed in a container of the present invention (referred to as “the present roasted green tea beverage packed in a container”) is characterized in that the concentration of saccharides, which is the sum of the concentration of monosaccharides and the concentration of disaccharides, is 60 ppm to 220 ppm, the ratio of the concentration of disaccharides relative to the concentration of monosaccharides (disaccharides/monosaccharides) is 5.0 to 15.0, and the ratio of the concentration of saccharides relative to the concentration of gallic acid (saccharides/gallic acid) is 2.0 to 5.0.

A monosaccharide is a hydrocarbon represented by a general formula C₆(H₂O)₆, and is not hydrolyzed any more to further simply saccharide. The monosaccharide referred to in the present invention represents glucose or fructose.

A disaccharide is a hydrocarbon represented by a general formula C₁₂(H₂O)₁₁, and is hydrolyzed to give a monosaccharide. The disaccharide referred to in the present invention represents sucrose, cellobiose or maltose.

When the concentration of saccharides which is the sum of monosaccharides and disaccharides (hereinafter, referred to as the concentration of saccharides.), is 60 ppm to 220 ppm, it allows a beverage that has a balance of the taste and the odor being maintained, and has sweet taste and richness, and has small bitter astringent taste and coarse taste, etc. in the aftertaste even when the present green tea beverage is drunk after a long storage at normal temperature, or in a cold state.

From such viewpoint, the concentration of saccharides is preferably 100 ppm to 200 ppm, particularly preferably 155 ppm to 180 ppm.

In adjustment of the concentration of saccharides to the above-described range, roasting process or extraction of tea leaves may be adjusted to suitable conditions. For example, if the roasting process of the tea leaves is performed strongly, the saccharides are decomposed and decrease. In addition, if the tea leaves are extracted at high temperature for a long time, the saccharides are decomposed and decrease. Therefore, the concentration of saccharides may be adjusted by the roasting conditions and the extraction conditions of the tea leaves.

At this time, although the adjustment may be performed by addition of saccharides, this has a fear of collapsing the original aroma balance of the roasted green tea beverage, so the adjustment is preferably not performed by addition of saccharides, but by adjusting conditions for obtaining a tea extraction liquid, and in addition, by mixing of the tea extraction liquids with each other, or by addition of a tea extract, or the like.

In addition, if the ratio of the concentration of disaccharides relative to the concentration of monosaccharides (disaccharides/monosaccharides) is 5.0 to 15.0, the present roasted green tea beverage packed in a container becomes a beverage that has strong roasting aroma, and allows enjoyment of spreading and sustaining odor in the mouth.

From such viewpoint, the ratio of the concentration of disaccharides relative to the concentration of monosaccharides (disaccharides/monosaccharides) is preferably 7.0 to 13.0, and particularly preferably 10.0 to 11.0.

In adjustment of the ratio of the concentration of disaccharides relative to the concentration of monosaccharides to the above-described range, roasting process or extraction of tea leaves may be adjusted to suitable conditions. For example, when the tea leaves are subjected to roasting process, monosaccharides decrease first, and then disaccharides decrease. Therefore, the ratio of disaccharides/monosaccharides can be lowered by subjecting the tea leaves to strong roasting and performing extraction at high temperature for a short time, or the like.

At this time, although the adjustment may be performed by addition of saccharides, this has a fear of collapsing the original aroma balance of the roasted green tea beverage, so the adjustment is preferably not performed by addition of saccharides, but by adjusting conditions for obtaining a tea extraction liquid, and in addition, by mixing of the tea extraction liquids with each other, or by addition of a tea extract, or the like.

The concentration of gallic acid in the present roasted green tea beverage packed in a container is preferably 30 ppm to 75 ppm.

The concentration of gallic acid is more particularly preferably 32 ppm to 58 ppm, and further particularly preferably 32 ppm to 53 ppm.

Herein, the “gallic acid” is a common name of 3,4,5-trihydroxybenzene carboxylic acid.

In adjustment of the concentration of gallic acid to the above-described range, roasting process or extraction of tea leaves may be adjusted to suitable conditions. For example, the concentration of gallic acid may be elevated by roasting at high temperature or alkali extraction at high temperature.

In the present roasted green tea beverage packed in a container, the ratio of the concentration of saccharides to the concentration of gallic acid (saccharides/gallic acid) is preferably 2.0 to 5.0. When the ratio is within this range, the present roasted green tea beverage packed in a container becomes a beverage that has a balance of astringent taste and sweet taste and has excellent aftertaste.

From such viewpoint, the ratio of the concentration of saccharides relative to the concentration of gallic acid (saccharides/gallic acid) is particularly preferably, 2.3 to 4.7, and further preferably 2.8 to 3.1.

In adjustment of the ratio of the concentration of saccharides relative to the concentration of gallic acid to the above-described range, suitable conditions may be set up considering the facts that saccharides are decomposed, and the concentration of gallic acid increases with strong roasting conditions, that saccharides are decomposed with extraction at high temperature, and the like.

The concentration of the total catechins in the present roasted green tea beverage packed in a container is preferably 90 ppm to 300 ppm.

The concentration of total catechins is more particularly preferably 100 ppm to 250 ppm, and further particularly preferably 100 ppm to 200 ppm.

At this time, total catechins mean total 8 kinds of catechin (C), gallocatechin (GC), catechin gallate (Cg), gallocatechin gallate (GCg), epicatechin (EC), epigallocatechin (EGC), epicatechin gallate (ECg), and epigallocatechin gallate (EGCg), and the concentration of total catechins mean total values of the concentrations of the 8 kind catechins.

In adjustment of the concentration of total catechins to the above-described range, the concentration of the total catechins may be adjusted by extraction conditions. At this time, although the adjustment may be performed by addition of saccharides, this has a fear of collapsing the original aroma balance of the roasted green tea beverage, so the adjustment is preferably not performed by addition of saccharides, but by adjusting conditions for obtaining a tea extraction liquid, and in addition, by mixing of the tea extraction liquids with each other, or by addition of a tea extract, or the like.

The concentration of the electron-localized catechins in the present roasted green tea beverage packed in a container is preferably 80 ppm to 240 ppm.

The concentration of the electron-localized catechins is particularly more preferably 85 ppm to 210 ppm, and further particularly preferably 85 ppm to 170 ppm.

The “electron-localized catechin” referred to in the present invention is a catechin that has a triol structure (a structure having 3 OH groups adjacent to the benzene ring), and is considered to be likely to have localization of the electric charge when ionized. Specifically, the “electron-localized catechin” includes epigallocatechin gallate (EGCg), epigallocatechin (EGC), epicatechin gallate (ECg), gallocatechin gallate (GCg), gallocatechin (GC), catechin gallate (Cg) and the like.

In adjustment of the concentration of the electron-localized catechins to the above-described range, the concentration of the electron-localized catechins may be adjusted with the extraction conditions. However, the concentration of the electron-localized catechins easily changes with the extraction time and the temperature, and thus if the temperature is too high, or the extraction time is too long, it is not preferable also in view of holding the aroma of the beverage. At this time, although the adjustment may be performed by addition of the electron-localized catechins, this has a fear of collapsing the balance of a roasted green tea beverage. Therefore, the adjustment is preferably performed by adjustment of conditions for obtaining a tea extraction liquid, alternatively by mixing of the tea extraction liquids with each other, by addition of a tea extract, or the like.

The ratio of the concentration of the electron-localized catechins relative to the concentration of saccharides (electron-localized catechins/saccharides) in the present roasted green tea beverage packed in a container is preferably 0.8 to 1.8. When the ratio is within this range, the present roasted green tea beverage packed in a container becomes a delicious beverage that has a balance of astringent taste and sweet taste, and also has a balance with roasting aroma spreading in the mouth even when the beverage is drunk in a cold state.

From such viewpoint, the ratio of the concentration of electron-localized catechins relative to the concentration of saccharides (electron-localized catechins/saccharides) is particularly preferably 1.1 to 1.7, and further particularly preferably 1.2 to 1.4.

In adjustment of the ratio of the concentration of electron-localized catechins relative to the concentration of saccharides to the above-described range, the ratio may be adjusted with the extraction conditions. However although the extraction rate of catechins increases at high temperature, saccharides are likely to be decomposed at high temperature, and thus the extraction time is preferably short. At this time, although the adjustment may be performed by addition of the electron-localized catechin and the saccharides, this has a fear of collapsing the balance of a roasted green tea beverage, so the adjustment is preferably performed by adjusting conditions for obtaining a tea extraction liquid, and in addition, by mixing of the tea extraction liquids with each other, or by addition of a tea extract, or the like.

The concentration of caffeine in the present roasted green tea beverage packed in a container is preferably 90 ppm to 190 ppm.

The concentration of caffeine is particularly more preferably 100 ppm to 180 ppm, and further particularly preferably 120 ppm to 160 ppm.

In adjustment of the concentration of caffeine to the above-described range, the concentration of caffeine may be adjusted with the amount of tea leaves and extraction temperature. At this time, although the adjustment may be performed by addition of caffeine, this has a fear of collapsing the balance of a roasted green tea beverage, so the adjustment is preferably performed by adjusting conditions for obtaining a tea extraction liquid, and in addition, by mixing of the tea extraction liquids with each other, or by addition of a tea extract, or the like.

In addition, the ratio of the concentration of total catechins relative to the concentration of caffeine (total catechins/caffeine) in the present roasted green tea beverage packed in a container is preferably 0.5 to 4.5.

The ratio of the concentration of total catechins relative to the concentration of caffeine (total catechins/caffeine) is particularly more preferably 1.0 to 4.0, and further particularly preferably 1.0 to 2.5.

In adjustment of the ratio of the concentration of total catechins relative to the concentration of caffeine to the above-described range, the ratio may be adjusted with the amount of tea leaves and extraction temperature. At this time, although the adjustment may be performed by addition of total catechins and caffeine, this has a fear of collapsing the balance of the roasted green tea beverage, so the adjustment is preferably performed by adjusting conditions for obtaining a tea extraction liquid, and in addition, by mixing of the tea extraction liquids with each other, or by addition of a tea extract, or the like.

The concentration of the soluble solid content derived from tea leaves in the present roasted green tea beverage packed in a container, is preferably 0.18% to 0.45%. Herein, the soluble solid content derived from tea leaves is a sucrose-converted value of the soluble solid content obtained from extraction of the green tea.

From such viewpoint, the concentration of the soluble solid content derived from tea leaves in the present roasted green tea beverage packed in a container is particularly more preferably 0.22% to 0.40%, and further particularly preferably 0.22% to 0.30%.

In adjustment of the concentration of the soluble solid content derived from tea leaves to the above-described range, the adjustment may be performed by suitably adjusting the amount of tea leaves and extraction conditions.

In the present roasted green tea beverage packed in a container, the ratio of the concentration of saccharides relative to the concentration of the soluble solid content derived from tea leaves (saccharides/(the soluble solid content derived from tea leaves×100)) is preferably 2.0 to 10.0.

The ratio of the concentration of saccharides relative to the concentration of the soluble solid content derived from tea leaves is particularly more preferably 2.5 to 8.0, and further particularly preferably 3.0 to 7.0.

In adjustment of the ratio of the concentration of saccharides relative to the concentration of the soluble solid content derived from tea leaves to the above-described range, the concentration of the soluble solid content may be elevated by increasing the amount of tea leaves, and the ratio may be adjusted by combination with roasting conditions for the raw tea. At this time, although the adjustment may be performed by addition of saccharides, this has a fear of collapsing the balance of the roasted green tea beverage, so the adjustment is preferably performed by adjusting conditions for obtaining a tea extraction liquid, and in addition, by mixing of the tea extraction liquids with each other, or by addition of a tea extract, or the like.

In the present roasted green tea beverage packed in a container, the ratio of the concentration of total catechins relative to the concentration of the soluble solid content derived from tea leaves (total catechins/(the soluble solid content derived from tea leaves×100)) is preferably 3.0 to 10.0.

The ratio of the concentration of total catechins relative to the concentration of the soluble solid content derived from tea leaves is particularly more preferably 4.0 to 9.0, and further particularly preferably 5.0 to 8.0.

In adjustment of the ratio of the concentration of total catechins relative to the concentration of the soluble solid content derived from tea leaves to the above-described range, the ratio may be adjusted with roasting conditions or extraction conditions. At this time, although the adjustment may be performed by addition of catechins, this has a fear of collapsing the balance of the roasted green tea beverage, so the adjustment is preferably performed by adjusting conditions for obtaining a tea extraction liquid, and in addition, by mixing of the tea extraction liquids with each other, or by addition of a tea extract, or the like.

In the present roasted green tea beverage packed in a container, the ratio of the electron-localized catechins relative to the concentration of the soluble solid content derived from tea leaves (electron-localized catechins/(the soluble solid content derived from tea leaves×100)) is preferably 5.0 to 9.0. When the ratio is within this range, the present roasted green tea beverage packed in a container becomes a delicious beverage that has a balance of roasting aroma and astringent taste and also has afterglow of odor even when drunk in a cold state.

The ratio of the concentration of the electron-localized catechins relative to the concentration of the soluble solid content derived from tea leaves is particularly more preferably 5.2 to 8.9, and further particularly preferably 5.8 to 7.5.

In adjustment of the ratio of the concentration of the electron-localized catechins relative to the concentration of the soluble solid content derived from tea leaves to the above-described range, the roasting is preferably performed at high temperature as the roasting conditions for tea leaves. In addition, the ratio may be adjusted with extraction conditions and the like since dissolution of catechins varies with extraction temperature. At this time, although the adjustment may be performed by addition of electron-localized catechins, this has a fear of collapsing the balance of the roasted green tea beverage, so the adjustment is preferably performed by adjusting conditions for obtaining a tea extraction liquid, and in addition, by mixing of the tea extraction liquids with each other, or by addition of a tea extract, or the like.

The pH of the present roasted green tea beverage packed in a container is preferably 6.0 to 6.5 at 20° C. The pH of the present roasted green tea beverage packed in a container is particularly more preferably 6.0 to 6.4, and particularly further preferably 6.1 to 6.3.

The concentrations of monosaccharides, disaccharides, gallic acid, electron-localized catechins, total catechins and caffeine described above can be measured by a calibration curve method or the like using a high performance liquid chromatogram (HPLC) or the like.

(Container)

A container to be filled with the present roasted green tea beverage packed in a container is not particularly limited. For example, a plastic-made bottle (so-called PET bottle), a can made of a metal such as steel and aluminum, a bottle, a paper container or the like may be used, and particularly, a transparent container such as a PET bottle or the like may be preferably used as the container.

(Manufacturing Method)

The present roasted green tea beverage packed in a container may be manufactured by, for example, selecting raw materials for tea leaves, and suitably adjusting conditions for a dry (fire) process and extraction for tea leaves, whereby to adjust the concentration of saccharides which is the sum of the concentration of monosaccharides and the concentration of disaccharides to 60 ppm to 220 ppm, the ratio of the concentration of disaccharides relative to the concentration of monosaccharides (disaccharides/monosaccharides) to 5.0 to 15.0, and the ratio of the concentration of saccharides relative to the concentration of gallic acid (saccharides/gallic acid) to 2.0 to 5.0 in the beverage.

For example, the present roasted green tea beverage packed in a container can be manufactured by preparing an extraction liquid, which is obtained by subjecting tea leaves to roasting at 330° C. to 375° C. and extracting the tea leaves at high temperature for a short time, and a conventional general roasted green tea extraction liquid, i.e., an extraction liquid that is obtained by subjecting tea leaves to roasting process at 180° C. to 310° C. and extracting the tea leaves at high temperature for a short time, and then blending them in a suitable ratio. However, the invention is not limited to such manufacturing method.

As described above, by performing the roasting process to tea leaves, the monosaccharides decrease first, and then the disaccharides decrease. Accordingly, by adjustment of the conditions for the roasting process, the concentration of saccharides and the value of disaccharides/monosaccharides may be adjusted.

(Explanation for Terms)

The “roasted green tea beverage” in the present invention means a beverage containing a tea extraction liquid or tea extract that is obtained from tea extraction, as a major component.

In addition, the “roasted green tea beverage packed in a container” means a roasted green tea beverage that is packed in a container, and also means a roasted green tea beverage that may be provided for drinking without dilution.

When “X to Y” (X and Y are any number) is expressed in the present specification, it encompasses the meaning of “X or more and Y or less”, and also the meaning of “preferably greater than X” and “preferably less than Y” unless otherwise stated.

### EXAMPLES

Hereinafter, Examples of the present invention will be explained. However, the present invention is not limited to this Example.

The “concentration of monosaccharides” in Examples means a total concentration of glucose and fructose, and the “concentration of disaccharides” means a total concentration of sucrose, cellobiose and maltose.

<Evaluation Test 1>

Extraction Liquids A to E described below were prepared, and using these extraction liquids, the roasted green tea beverages of Examples 1 to 4 and Comparative Examples 1 to 4 were prepared, and sensory evaluations therefor were performed.

(Extraction Liquid A)

Tea leaves after plucking (Yabukita species, first flush tea produced in Shizuoka Prefecture) were subjected to Aracha process, and subjected to roasting process with a rotation drum type drying machine under the conditions of 200° C. of the setting temperature and 30 minutes of the roasting time. The tea leaves were extracted under the conditions of 8 g of the tea leaves, 1 L of 50° C. hot water and 5.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid A.

(Extraction Liquid B)

Tea leaves after plucking (Yabukita species, first flush tea produced in Shizuoka Prefecture) were subjected to Aracha process, and subjected to roasting process with a rotation drum type drying machine under the conditions of 300° C. of the setting temperature and 10 minutes of the roasting time. The tea leaves were extracted under the conditions of 7 g of the tea leaves, 1 L of 65° C. hot water and 7 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid B.

(Extraction Liquid C)

Tea leaves after plucking (Yabukita species, first flush tea produced in Shizuoka Prefecture) were subjected to Aracha process, and subjected to roasting process with a rotation drum type drying machine under the conditions of 350° C. of the setting temperature and 1 minute of the roasting time. The tea leaves were extracted under the conditions of 12 g of the tea leaves, 1 L of 90° C. hot water and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid C.

(Extraction Liquid D)

Tea leaves after plucking (Yabukita species, first flush tea produced in Shizuoka Prefecture) were subjected to Aracha process, and subjected to roasting process with a rotation drum type drying machine under the conditions of 370° C. of the setting temperature and 1 minute of the roasting time. The tea leaves were extracted under the conditions of 11 g of the tea leaves, 1 L of 90° C. hot water and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid D.

(Extraction Liquid E)

Tea leaves after plucking (Yabukita species, first flush tea produced in Shizuoka Prefecture) were subjected to Aracha process, and subjected to roasting process with a rotation drum type drying machine under the conditions of 310° C. of the setting temperature and 10 minutes of the roasting time. The tea leaves were extracted under the conditions of 8 g of the tea leaves, 1 L of 90° C. hot water and 10 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid E.

(Analysis of Extraction Liquids)

1/10 amount of each extraction liquid described above was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C. and measured for analysis of the components of each extraction liquid.

The results of the analyses are shown in Table 1 described below. The measurement method is as described below.

TABLE 1

| | | | | | Soluble | | | | |
|---|---|---|---|---|---|---|---|---|---|
| | | | | | solid | | | | Amount |
| | | Concentration | | Electron- | content | | | | of tea |
| | | of | | localized | derived | | Extraction | Extraction | leaves |
| | Disaccharides/ | saccharides | Saccharides/ | catechins | from tea | Conditions for | temperature | time | used |
| | Monosaccharides | (ppm) | Gallic acid | (ppm) | leaves (%) | roasting | (° C.) | (Minute) | (g/l) |
| A | 5.42 | 120.3 | 5.36 | 282.4 | 0.21 | 200° C. of firing | 50 | 5.5 | 8 |
| | | | | | | for 30 minutes | | | |
| B | 16.67 | 143.5 | 7.03 | 220.2 | 0.19 | 300° C. of firing | 65 | 7 | 7 |
| | | | | | | for 10 minutes | | | |
| C | 11.00 | 160.0 | 3.00 | 211.2 | 0.31 | 350° C. of firing | 90 | 3.5 | 12 |
| | | | | | | for 1 minutes | | | |
| D | 4.89 | 91.2 | 1.20 | 75.8 | 0.24 | 370° C. of firing | 90 | 3.5 | 11 |
| | | | | | | for 1 minutes | | | |
| E | 15.20 | 111.2 | 3.20 | 143.5 | 0.20 | 310° C. of firing | 90 | 10 | 8 |
| | | | | | | for 10 ninutes | | | |

(Blending)

Each of the Extraction Liquids A to E was blended in the ratios shown in Table 2 below, added with ascorbic acid in 400 ppm, and then added with sodium bicarbonate to adjust pH to 6.2, and added with ion-exchanged water to adjust the total amount to 1000 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C., to prepare the roasted green tea beverages of Examples 1 to 4 and Comparative Examples 1 to 4.

TABLE 2

| | | | | | Comparative | Comparative | Comparative | Comparative |
|---|---|---|---|---|---|---|---|---|
| | Example | Example | Example | Example | Example | Example | Example | Example |
| | 1 | 2 | 3 | 4 | 1 | 2 | 3 | 4 |
| A | 0 | 0 | 0 | 40 | 0 | 0 | 90 | 0 |
| B | 0 | 40 | 0 | 0 | 80 | 0 | 0 | 0 |
| C | 60 | 60 | 100 | 40 | 20 | 0 | 10 | 0 |
| D | 40 | 0 | 0 | 20 | 0 | 100 | 0 | 0 |
| E | 0 | 0 | 0 | 0 | 0 | 0 | 0 | 100 |
| Total | 100 | 100 | 100 | 100 | 100 | 100 | 100 | 100 |
| ratio | | | | | | | | |

TABLE 3

| | | | | | Comparative | Comparative | Comparative | Comparative |
|---|---|---|---|---|---|---|---|---|
| | Example | Example | Example | Example | Example | Example | Example | Example |
| | 1 | 2 | 3 | 4 | 1 | 2 | 3 | 4 |
| Concentration | 132.5 | 153.4 | 160.0 | 130.4 | 146.8 | 91.2 | 124.3 | 111.2 |
| Of | | | | | | | | |
| Saccharides | | | | | | | | |
| (ppm) | | | | | | | | |
| Disaccharide/ | 8.56 | 13.27 | 11.00 | 7.55 | 15.54 | 4.89 | 5.98 | 15.20 |
| Monosaccharide | | | | | | | | |
| Saccarides/ | 2.28 | 4.61 | 3.00 | 3.58 | 6.22 | 1.20 | 5.12 | 3.20 |
| Gallic acid | | | | | | | | |
| Electron- | 157.0 | 214.8 | 211.2 | 212.6 | 218.4 | 75.8 | 275.3 | 143.5 |
| Localized | | | | | | | | |
| Catechins | | | | | | | | |
| (ppm) | | | | | | | | |
| Caffeine | 153.5 | 140.1 | 158.2 | 139.3 | 122.0 | 146.5 | 121.0 | 108.9 |
| (ppm) | | | | | | | | |
| pH | 6.2 | 6.2 | 6.2 | 6.2 | 6.2 | 6.2 | 6.2 | 6.2 |
| Total | 181.8 | 245.8 | 245.2 | 240.9 | 246.5 | 86.7 | 306.9 | 163.6 |
| Catechins | | | | | | | | |
| (ppm) | | | | | | | | |
| Soluble Solid | 0.28 | 0.26 | 0.31 | 0.25 | 0.21 | 0.24 | 0.22 | 0.20 |
| Content | | | | | | | | |
| Derived From | | | | | | | | |
| Tea Leaves | | | | | | | | |
| (%) | | | | | | | | |
| Brix (%) | 0.34 | 0.31 | 0.37 | 0.31 | 0.26 | 0.30 | 0.26 | 0.25 |
| Strength of | ⊚ | ⊚ | ⊚ | ○ | Δ | ○ | x | Δ |
| Roasting | | | | | | | | |
| Aroma | | | | | | | | |
| Spreading of | ○ | ○ | ⊚ | ○ | Δ | x | x | Δ |
| Roasting | | | | | | | | |
| Aroma | | | | | | | | |
| Deteriorated | ○ | ○ | ○ | ○ | ○ | x | ○ | Δ |
| Smell (Oily | | | | | | | | |
| smell) | | | | | | | | |
| Total | ○ | ○ | ⊚ | ○ | Δ | x | x | Δ |
| Evaluation | | | | | | | | |

(Analysis)

The components and pH of the roasted green tea beverages of Examples 1 to 4 and Comparative Examples 1 to 4 were measured as shown below. The results are shown in Table 3 described above.

The concentration of monosaccharides and the concentration of disaccharides were quantity-measured by a calibration curve method with manipulation of a HPLC saccharide analysis equipment (manufactured by Dionex Corporation) under the conditions described below.

Column: “Carbopack PA1 φ4.6×250 mm” manufactured by Dionex Corporation

Column Temperature: 30° C.

Mobile Phase:
Phase A 200 mM NaOH
Phase B 1000 mM Sodium Acetate
Phase C Ultrapure water

Flow Rate: 1.0 mL/min

Injection Amount: 25 μL

Detection: “ED50 gold electrode” manufactured by Dionex Corporation

The concentration of gallic acid, the concentration of electron-localized catechins, the concentration of total catechins and the concentration of caffeine were quantity-measured by a calibration curve method with manipulation of a high performance liquid chromatogram (HPLC) under the conditions described below.

Column: “Xbridge shield RP18 φ3.5×150 mm” manufactured by Waters Corporation

Column Temperature: 40° C.

Mobile Phase:
Phase A Water
Phase B Acetonitrile
Phase C 1% phosphoric acid

Flow Rate: 0.5 mL/min

Injection Amount: 5 μL

Detection: “UV230 nm UV detector” manufactured by Waters Corporation

The pH was measured with “F-24”, a pH meter manufactured by HORIBA, Ltd. according to an ordinary method.

The concentration of the soluble solid content (Brix) was measured with “DD-7” manufactured by ATAGO CO., LTD.

(Evaluation Item)

Using the roasted green tea beverages of Examples 1 to 4 and Comparative Examples 1 to 4, strength of roasting aroma, spreading of roasting aroma and deteriorated smell (oily smell) were evaluated.

(Evaluation Test)

The roasted green tea beverages of Examples 1 to 4 and Comparative Examples 1 to 4 (25° C. temperature) were tasted immediately after the preparation for the strength of roasting aroma and the spreading of roasting aroma by five persons of trained examiners. Then, the roasted green tea beverages of Examples 1 to 4 and Comparative Examples 1 to 4 (25° C. temperature) were tasted after the prepared roasted green tea beverages were stored at 55° C. for one month, for deteriorated smell. Each beverage was given scores by the standards as described below. The evaluations for the average points of the five persons were performed wherein “⊚” indicates 3.5 or more, “∘” indicates 3 or more and less than 3.5, “Δ” indicates 2 or more and less than 3, and “x” indicates 1 or more and less than 2. The results thereof are shown in Table 3 described above.

<Strength of Roasting Aroma>

Particularly Strong=4

Strong=3

Present=2

Weak=1

<Spreading of Roasting Aroma>

Particularly Strong=4

Strong=3

Present=2

Weak=1

<Deteriorated Smell>

Absent=4

Slightly Present=3

Sensed=2

Strong=1

(Total Evaluation)

The average points of the above-described three evaluation tests were computed. The total evaluations for the average points were performed wherein “⊚” indicates 3.5 or more, “∘” indicates 3 or more and less than 3.5, “Δ” indicates 2 or more and less than 3, and “x” indicates 1 or more and less than 2.

For any of Examples 1 to 4, excellent results were obtained, of which the total evaluation was “∘” or better.

On the other hand, for Comparative Examples 1 to 4, the results were not preferable, of which the evaluation was “Δ” for Comparative Examples 1 and 4 and “x” for Comparative Examples 2 and 3.

From the results of Comparative Example 2, it was found that if the value of the disaccharides/monosaccharides decreases, bitter taste or bitterness occurs, and further the smell is temporally deteriorated and unpleasant smell generally called oily smell, becomes sensed. From the results of Comparative Examples 1 and 4, it was found that if the value of the disaccharides/monosaccharides increases, the roasting aroma becomes weaker, and does not spread in the mouth.

In addition, from the results of Comparative Example 2, it was found that if the value of the saccharides/gallic acid decreases, the odor does not spread. From the results of Comparative Examples 1 and 3, it was found that if the value of the saccharides/gallic acid increases, the roasting aroma becomes weaker and does not spread in the mouth.

From these results, it is assumed that the ranges of the ratio of the concentration of disaccharides relative to the concentration of monosaccharides (disaccharides/monosaccharides) being 5.0 to 15 and the ratio of the concentration of saccharides relative to the concentration of gallic acid (saccharides/gallic acid) being 2.0 to 5.0, are ranges that allow the evaluations for the strength of roasting aroma, the spreading of roasting aroma and the deteriorated smell to become better. It was discovered that a roasted green tea beverage of which these items are in these ranges, has strong roasting aroma, and has clean and yet refreshing aftertaste, and can be drunk delectably even in a cold state.

<Evaluation Test 2>

Extraction Liquids F and G described below were prepared, and using these extraction liquids, roasted green tea beverages of Examples 5 to 9 were prepared, and sensory evaluations with age were performed.

(Extraction Liquid F)

Tea leaves after plucking (Yabukita species, first flush tea produced in Shizuoka Prefecture) were subjected to Aracha process, and subjected to roasting process with a rotation drum type drying machine under the conditions of 355° C. of the setting temperature and 1 minute of the roasting time. The tea leaves were extracted under the conditions of 11 g of the tea leaves, 1 L of 90° C. hot water and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid F.

(Extraction Liquid G)

Tea leaves after plucking (Yabukita species, first flush tea produced in Shizuoka Prefecture) were subjected to Aracha process, and subjected to roasting process with a rotation drum type drying machine under the conditions of 320° C. of the setting temperature and 1 minute of the roasting time. The tea leaves were extracted under the conditions of 10 g of the tea leaves, 1 L of 90° C. hot water, and 3 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m2 of the centrifugal sedimentation liquid area (Σ), to prepare Extraction Liquid G.

(Analysis of Extraction Liquids)

1/10 amount of each of the extraction liquids F and G was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C. and measured for analysis of the components of each extraction liquid.

The results of the analyses are shown in Table 4 described below. The measurement method is as described above.

TABLE 4

| | | | | | Soluble | | | |
|---|---|---|---|---|---|---|---|---|
| | | | | | Solid | | | |
| | Concentration | | | Electron- | Content | | Amount of | |
| | of | | | localized | Derived | Conditions | tea | Extraction |
| | saccharides | Disaccharide/ | Saccharides/ | catechins | From Tea | for | leaves | time |
| | (ppm) | Monosaccharide | Gallic acid | (ppm) | Leaves (%) | roasting | used(g/L) | (Min.) |
| F | 132.0 | 8.90 | 2.22 | 129.6 | 0.26 | 355° C. | 11 | 3.3 |
| | | | | | | of firing | | |
| | | | | | | for 1 min. | | |
| G | 194.8 | 11.98 | 3.87 | 215.0 | 0.23 | 320° C. | 10 | 3 |
| | | | | | | of firing | | |
| | | | | | | for 1 min. | | |

(Blending)

Extraction Liquids F and G were blended in the ratios shown in Table 5 below, added with ascorbic acid in 400 ppm, and then added with sodium bicarbonate to adjust pH to 6.2, and added with ion-exchanged water to adjust the total amount to 1000 mL. This liquid was filled into a heat-resistant transparent container (bottle) and capped, and over-turn sterilized for 30 seconds. The sterilization was performed to 9 or more of F₃ value for retort sterilization (121° C., 9 minutes), and the solution was immediately cooled to 20° C., to prepare the roasted green tea beverages of Examples 5 to 9. The results of the measurements for the components and pH of the roasted green tea beverages of Examples 5 to 9 are shown in Table 6 described below. The concentration of saccharides, the concentration of electron-localized catechins, the concentration of caffeine, the concentration of total catechins, the concentration of the soluble solid content derived from tea leaves, and pH were measured in the same manner as described above.

TABLE 5

| | Example | Example | Example | Example | Example |
|---|---|---|---|---|---|
| | 5 | 6 | 7 | 8 | 9 |
| F | 80 | 50 | 20 | 100 | 0 |
| G | 20 | 50 | 80 | 0 | 100 |
| Total | 100 | 100 | 100 | 100 | 100 |
| ratio | | | | | |

TABLE 6

| | | Example 5 | Example 6 | Example 7 | Example 8 | Example 9 |
|---|---|---|---|---|---|---|
| Electron-Localized | | 5.64 | 6.89 | 8.25 | 4.98 | 9.35 |
| Catechins/(Soluble Solid | | | | | | |
| Content Derived From | | | | | | |
| Tea Leaves × 100) | | | | | | |
| Concentration Of Saccharides (ppm) | | 144.6 | 163.4 | 182.2 | 132.0 | 194.8 |
| Disaccharides/Monosaccharides | | 9.52 | 10.44 | 11.36 | 8.90 | 11.98 |
| Saccharides/Gallic acid | | 2.55 | 3.05 | 3.54 | 2.22 | 3.87 |
| Electron-Localized Catechins (ppm) | | 146.7 | 172.3 | 197.9 | 129.6 | 215.0 |
| Caffeine (ppm) | | 149.9 | 139.8 | 129.6 | 156.7 | 122.8 |
| pH | | 6.2 | 6.2 | 6.2 | 6.2 | 6.2 |
| Total Catechins (ppm) | | 168.5 | 197.9 | 227.2 | 148.9 | 246.3 |
| Soluble Solid Content Derived | | 0.26 | 0.25 | 0.24 | 0.26 | 0.23 |
| From Tea Leaves (%) | | | | | | |
| Brix (%) | | 0.31 | 0.30 | 0.30 | 0.32 | 0.29 |
| Change | Strength of | ○ | ○ | ○ | Δ | Δ |
| with age | roasting aroma | | | | | |
| | Spreading of | ○ | ⊚ | ○ | Δ | Δ |
| | roasting aroma | | | | | |
| | Deteriorated Smell | ○ | ○ | ○ | ○ | ○ |
| | (Oily smell) | | | | | |
| | Precipitate/Aggregate | − | − | − | − | ± |
| | Balance of flavor | ○ | ○ | ○ | Δ | Δ |
| | | Good balance | Good balance | Good balance | | |
| | | of flavor, | of flavor, | of flavor, | | |
| | | spread of roasting | strong and | roasting | | |
| | | aroma and | spreading | aroma and | | |
| | | appropriate | roasting | tight | | |
| | | concentration | aroma and | concentration | | |
| | | feeling | appropriate | feeling | | |
| | | | concentration | | | |
| | | | feeling | | | |

| | | | | | |
|---|---|---|---|---|---|
| Total Evaluation | ○ | ○ | ○ | Δ | Δ |

(Evaluation Item)

The roasted green tea beverages of Examples 5 to 9 were stored at 55° C. for one month, precipitate/aggregate, strength of roasting aroma, spreading of roasting aroma, deteriorated smell (oily smell), and a balance of flavor were evaluated.

(Evaluation Test)

The roasted green tea beverages of Examples 5 to 9 (25° C. temperature) were visually observed first for presence or absence of the precipitate/aggregate by five persons of trained examiners. Then, each beverage was tasted, and given scores by the standards as described below. The evaluations for the average points of the five persons were performed wherein “⊚” indicates 3.5 or more, “∘” indicates 3 or more and less than 3.5, “Δ” indicates 2 or more and less than 3, and “x” indicates 1 or more and less than 2. The results thereof are shown in Table 6 described above.

<Precipitate/Aggregate>

+: Some precipitate, which does not disappear with light stirring

±: Slight precipitate, which disappears with light stirring

−: No precipitate

<Strength of Roasting Aroma>

Particularly Strong=4

Strong=3

Present=2

Weak=1

<Spreading of Roasting Aroma>

Particularly Strong=4

Strong=3

Present=2

Weak-1

<Deteriorated Smell>

Absent=4

Slightly Present=3

Sensed=2

Strong=1

<Balance of Flavor>

Particularly good=4

Good=3

Slightly collapsed=2

Collapsed=1

(Total Evaluation)

The average points of the 5 evaluation tests of the strength of roasting aroma, the spreading of roasting aroma, deteriorated smell, the precipitate/aggregate, and the balance of flavor were computed. The total evaluations for the average points were performed wherein “⊚” indicates 3.5 or more, “∘” indicates 3 or more and less than 3.5, “Δ” indicates 2 or more and less than 3, and “x” indicates 1 or more and less than 2.

For any of Examples 5 to 7, excellent results were obtained, of which the total evaluation was “∘” or better.

On the other hand, for Examples 8 and 9, the evaluation was “Δ”, which were slightly worse than the results of Examples 5 to 7.

From the results of Example 8, it was found that if the value of the electron-localized catechins/(the soluble solid content derived from tea leaves×100) decreases, spreading of roasting aroma becomes somewhat weak, and the aroma is sensed further lighter. In addition, from the results of Example 9, it was found that if the value of the electron-localized catechins/(the soluble solid content derived from tea leaves×100) increases, the balance of roasting aroma is collapsed, and further precipitate is also generated.

From these results, it is assumed that the range of the electron-localized catechins/(the soluble solid content derived from tea leaves×100) being 5.0 to 9.0, is a range that allows no generation of the precipitate/aggregate even with age, and improvements in the strength of roasting aroma, the spreading of roasting aroma, the deteriorated smell, and the balance of flavor. It was discovered that a roasted green tea beverage of which these items are in these ranges, has strong roasting aroma, and has clean and yet refreshing aftertaste, and can be drunk delectably even in a cold state.

<Evaluation Test 3>

Extraction Liquids H and I described below were prepared, and using these extraction liquids, the roasted green tea beverages of Examples 10 to 14 were prepared, and evaluations for a balance of flavor were performed in sensory evaluations.

(Extraction Liquid H)

Tea leaves after plucking (Yabukita species, first flush tea produced in Shizuoka Prefecture) were subjected to Aracha process, and subjected to roasting process with a rotation drum type drying machine under the conditions of 355″C of the setting temperature and 1 minute of the roasting time. The tea leaves were extracted under the conditions of 11 g of the tea leaves, 1 L of 60° C. hot water and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid H.

(Extraction Liquid I)

Tea leaves after plucking (Yabukita species, first flush tea produced in Shizuoka Prefecture) were subjected to Aracha process, and subjected to roasting process with a rotation drum type drying machine under the conditions of 300° C. of the setting temperature and 10 minutes of the roasting time. The tea leaves were extracted under the conditions of 11 g of the tea leaves, 1 L of 93° C. hot water, and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid I.

(Analysis of Extraction Liquids)

1/10 amount of each of the extraction liquids H and I was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C. and measured for analysis of the components of each extraction liquid.

The results of the analyses are shown in Table 7 described below. The measurement method is as described above.

TABLE 7

| | | | | | Soluble | | | | |
|---|---|---|---|---|---|---|---|---|---|
| | | | | | Solid | | | Amount | |
| | Concentration | | | Electron- | Content | | | of tea | |
| | of | | | localized | Derived | Conditions | Temperature | leaves | Extraction |
| | saccharides | Disaccharide/ | Saccharide/ | catechins | From Tea | for | of roasting | used | time |
| | (ppm) | Monosaccharide | Gallic acid | (ppm) | Leaves (%) | roasting | (° C.) | (g/L) | (Min.) |
| H | 144.2 | 8.80 | 2.62 | 114.5 | 0.23 | 355° C. of | 60 | 11 | 3.5 |
| | | | | | | firing for | | | |
| | | | | | | 1 min. | | | |
| I | 108.1 | 12.30 | 3.37 | 220.1 | 0.27 | 300° C. of | 93 | 11 | 5 |
| | | | | | | firing for | | | |
| | | | | | | 10 min. | | | |

(Blending)

Extraction Liquids H and I were blended in the ratios shown in Table 8 below, added with ascorbic acid in 400 ppm, and then added with sodium bicarbonate to adjust pH to 6.2, and added with ion-exchanged water the total amount to adjust to 1000 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C., to prepare the roasted green tea beverages of Examples 10 to 14. The results of the measurements for the components and pH of the roasted green tea beverages of Examples 10 to 14 are shown in Table 9 described below. The concentration of saccharides, the concentration of electron-localized catechins, the concentration of caffeine, the concentration of total catechins, the concentration of the soluble solid content derived from tea leaves, and pH were measured in the same manner as described above.

TABLE 8

| | Example | Example | Example | Example | Example |
|---|---|---|---|---|---|
| | 10 | 11 | 12 | 13 | 14 |
| H | 80 | 50 | 20 | 100 | 10 |
| I | 20 | 50 | 80 | 0 | 90 |
| Total | 100 | 100 | 100 | 100 | 100 |
| ratio | | | | | |

TABLE 9

| | Example 10 | Example 11 | Example 12 | Example 13 | Example 14 |
|---|---|---|---|---|---|
| Electron-Localized | 0.99 | 1.33 | 1.73 | 0.79 | 1.88 |
| Catechins/Saccharides | | | | | |
| Concentration Of Saccharides | 137.0 | 126.2 | 115.3 | 144.2 | 111.7 |
| (ppm) | | | | | |
| Disaccharides/Monosaccharides | 9.50 | 10.55 | 11.60 | 8.80 | 11.95 |
| Electron-Localized Catechins | 135.6 | 167.3 | 199.0 | 114.5 | 209.5 |
| (ppm) | | | | | |
| Caffeine (ppm) | 156.4 | 168.1 | 179.8 | 148.6 | 183.7 |
| Saccharides/Gallic acid | 2.77 | 3.00 | 3.22 | 2.62 | 3.30 |
| pH | 6.2 | 6.2 | 6.2 | 6.2 | 6.2 |
| Total Catechins (ppm) | 155.4 | 192.2 | 229.0 | 130.8 | 241.3 |
| Soluble Solid Contest Derived | 0.24 | 0.25 | 0.26 | 0.23 | 0.26 |
| From Tea Leaves | | | | | |
| Brix (%) | 0.30 | 0.31 | 0.32 | 0.29 | 0.32 |
| Aftertaste (bitterness and | ◯ | ⊚ | ◯ | Δ | Δ |
| bitter taste) | | | | | |
| Balance of flavors | ◯ | ◯ | ◯ | ◯ | Δ |
| | Appropriate | Good | Appropriate | | |
| | sweet taste, | nutritious | nutritious | | |
| | spreading of | taste, | taste, | | |
| | roasting | spreading of | spreading | | |
| | aroma, and | roasting | of roasting | | |
| | clean taste | aroma, and | aroma, and | | |
| | | clean taste | clean taste | | |
| Total Evaluation | ◯ | ◯ | ◯ | Δ | Δ |

(Evaluation Item)

The roasted green tea beverages of Examples 10 to 14 were evaluated for the bitterness/astringent taste in the aftertaste and the balance of flavor.

(Evaluation Test)

The roasted green tea beverages of Examples 10 to 14 (25° C. temperature) were tasted by five persons of trained examiners, and given scores by the standards as described below. The evaluations for the average points of the five persons were performed wherein “⊚” indicates 3.5 or more, “∘” indicates 3 or more and less than 3.5, “Δ” indicates 2 or more and less than 3, and “x” indicates 1 or more and less than 2. The results thereof are shown in Table 9 described above.

<Bitterness/Astringent Taste in the Aftertaste>

Absent=4

Slightly Present=3

Sensed=2

Strong=1

<Balance of flavor>

Particularly good=4

Good=3

Slightly collapsed=2

Collapsed=1

(Total Evaluation)

The average points of the two evaluation tests were computed, and the total evaluations for the average points were performed wherein “⊚” indicates 3.5 or more, “∘” indicates 3 or more and less than 3.5, “Δ” indicates 2 or more and less than 3, and “x” indicates 1 or more and less than 2.

For any of Examples 10 to 12, excellent results were obtained, of which the total evaluation was “∘” or better.

On the other hand, for Examples 13 and 14, the evaluation was “Δ”, which were slightly worse than the results of Examples 10 to 12.

From the results of Example 13, it was found that if the value of the electron-localized catechins/saccharides decreases, the sweet taste remains somewhat strongly in the aftertaste, and particularly bitterness is sensed. In addition, from the results of Example 14, it was found that if the value of the electron-localized catechins/saccharides increases, the astringent taste is sensed slightly, and the balance of roasting aroma is collapsed.

From these results, it is assumed that the range of the electron-localized catechins/saccharides being 0.8 to 1.8, is a range that allows improvements in the bitterness/astringent taste in the aftertaste and the balance of flavor. It was discovered that a roasted green tea beverage of which these items are in these ranges, has strong roasting aroma, and has clean and yet refreshing aftertaste, and can be drunk delectably even in a cold state.

1. A roasted green tea beverage packed in a container wherein the concentration of saccharides, the sum of the concentration of monosaccharides and the concentration of disaccharides, is 60 ppm to 220 ppm, the ratio of the concentration of disaccharides relative to the concentration of monosaccharides (disaccharides/monosaccharides) is 5.0 to 15.0, and the ratio of the concentration of saccharides relative to the concentration of gallic acid (saccharides/gallic acid) is 2.0 to 5.0.

2. The roasted green tea beverage packed in a container according to claim 1 wherein the ratio of the concentration of electron-localized catechins relative to the concentration of the soluble solid content derived from tea leaves (electron-localized catechins; (the soluble solid content derived from tea leaves×100)) is 5.0 to 9.0.

3. The roasted green tea beverage packed in a container according to claim 1 wherein the ratio of the concentration of the electron-localized catechins relative to the concentration of saccharides (electron-localized catechins/saccharides) is 0.8 to 1.8.

4. A method for manufacturing a roasted green tea beverage packed in a container, the method comprising:
adjusting the concentration of saccharides, the sum of the concentration of monosaccharides and the concentration of disaccharides, to 60 ppm to 220 ppm;
adjusting the ratio of the concentration of disaccharides relative to the concentration of monosaccharides (disaccharides/monosaccharides) to 5.0 to 15.0; and
adjusting the ratio of the concentration of saccharides relative to the concentration of gallic acid (saccharides/gallic acid) to 2.0 to 5.0 in the roasted green tea beverage.

5. A method for improving flavor of a roasted green tea beverage packed in a container, the method comprising:
adjusting the concentration of saccharides, the sum of the concentration of monosaccharides and the concentration of disaccharides, to 60 ppm to 220 ppm;
adjusting the ratio of the concentration of disaccharides relative to the concentration of monosaccharides (disaccharides/monosaccharides) to 5.0 to 15.0; and
adjusting the ratio of the concentration of saccharides relative to the concentration of gallic acid (saccharides/gallic acid) to 2.0 to 5.0 in the roasted green tea beverage.
